(19) United States
(12) Patent Application Publication
(10) Pub. No.: US 2019/0047091 A1
(43) Pub. Date: Feb. 14, 2019

(54) Coppe coil and process of manufacturing same by means of laser cutting

(71) Applicants: Meng-I Huang, Kaohsiung (TW); Hsueh-Yi Hsiung, Kaohsiung (TW); Po-Nien Su, Kaohsiung (TW)

(72) Inventors: Meng-I Huang, Kaohsiung (TW); Hsueh-Yi Hsiung, Kaohsiung (TW); Po-Nien Su, Kaohsiung (TW)

(21) Appl. No.: 16/161,071

(22) Filed: Oct. 16, 2018

(51) Int. Cl. B23K 26/38

(52) U.S. Cl. CPC B23K 26/38

(57) ABSTRACT

A process of manufacturing a copper coil includes spirally cutting a piece of copper to form a plurality of grooves therein with the use of laser while adjusting a width of each groove to finish the copper coil including a coil unit having the grooves. The coil unit is either circular or spiral. A copper coil manufactured by the process is also provided.

### BACKGROUND OF THE INVENTION

### 1. Field of the Invention

The invention relates to the manufacturing of copper coil and more particularly to a copper coil and process of manufacturing same by means of laser cutting.

### 2. Description of Related Art

A conventional copper coil and process of manufacturing same by means of laser cutting is illustrated in FIG. 1. The process comprises cutting a piece of copper to form a plurality of grooves 2 therein by means of single laser so that a copper coil 1 can be manufactured at the end of the process. Cutting direction is indicated by arrow. A cutting width D of each groove 2 and a width L of copper unit are predetermined. Further, the grooves 2 are cut along both sides of the width L. Finally, a copper coil 1 is finished.

However, the conventional process of manufacturing a copper coil by means of laser cutting has the following drawbacks: The laser cutting is a single step. Also, cutting depth of the piece of copper is incomplete due to lower power. Further, it is not energy saving because a laser cutter consuming very much power is involved. Furthermore, the width of the groove is limited due to the specifications of the conventional laser cutters. Therefore, the laser cutter is required to cut a groove in a limited range. Adjustment is very difficult. And in turn, both yield and performance are low.

Thus, the need for improvement still exists.

### SUMMARY OF THE INVENTION

It is therefore one object of the invention to provide a process of manufacturing a copper coil comprising spirally cutting a piece of copper to form a plurality of grooves therein by means of laser while adjusting a width of each groove to finish the copper coil including a coil unit having the grooves.

It is another object of the invention to provide a copper coil comprising a coil unit including a plurality of grooves.

The above and other objects, features and advantages of the invention will become apparent from the following detailed description taken with the accompanying drawings.

### BRIEF DESCRIPTION OF THE DRAWINGS

FIG. 1 schematically depicts a process of manufacturing a copper coil according to the conventional art;

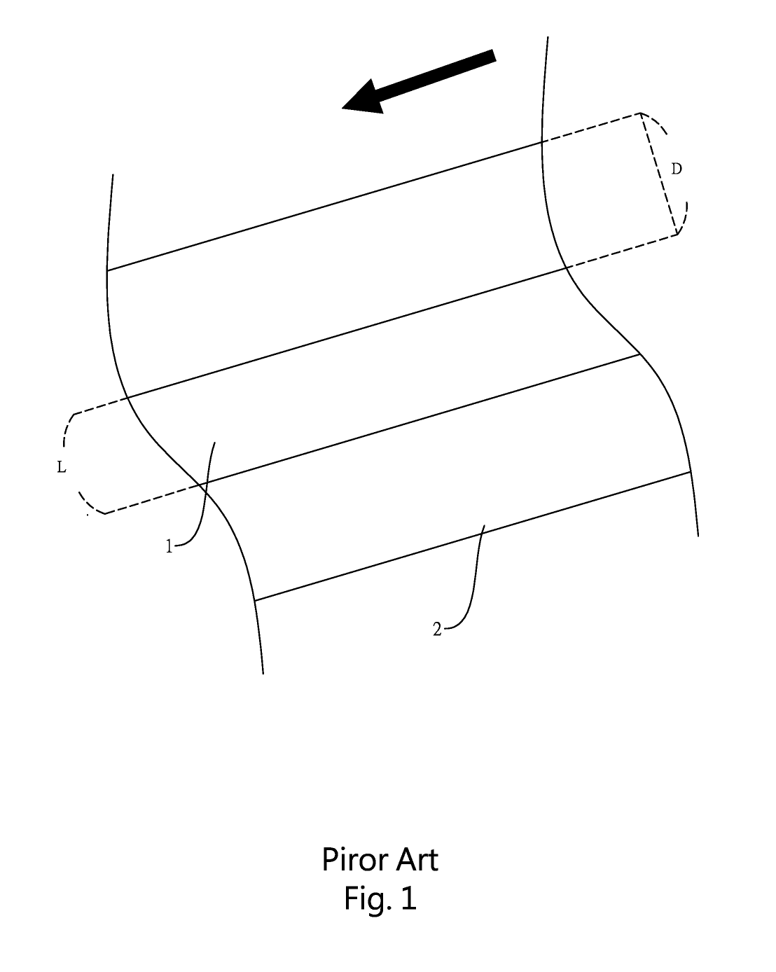

FIG. 2 schematically shows a copper coil manufactured by the process of the invention;

FIG. 2A is a detailed view of the area in circle 2A of FIG. 2;

FIG. 3 is a greatly enlarged view of FIG. 2A; and

FIG. 4 schematically depicts the step of cutting a piece of copper to form a plurality of grooves therein by means of laser according to a process of the invention.

### DETAILED DESCRIPTION OF THE INVENTION

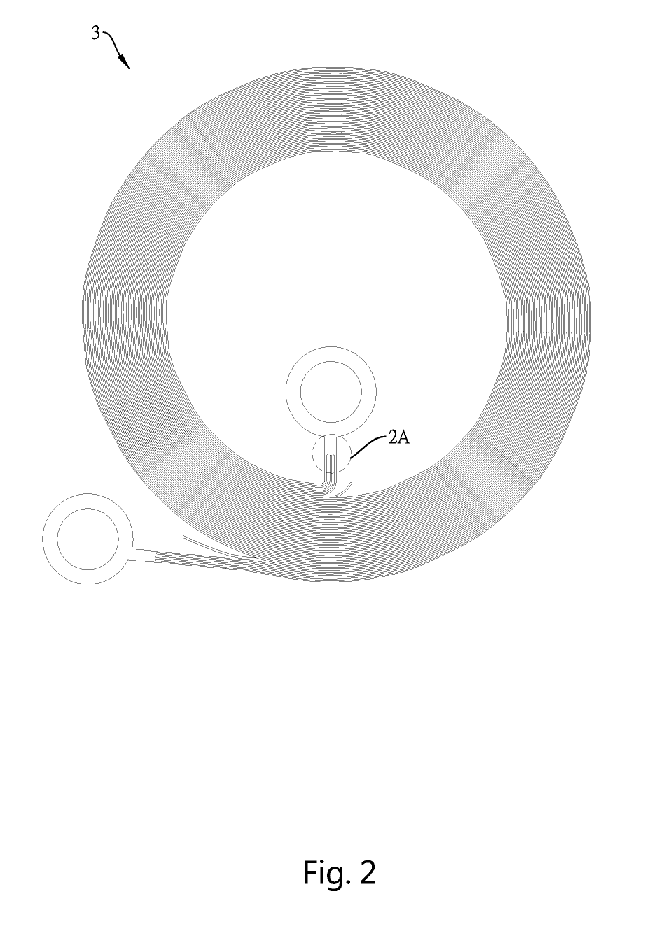

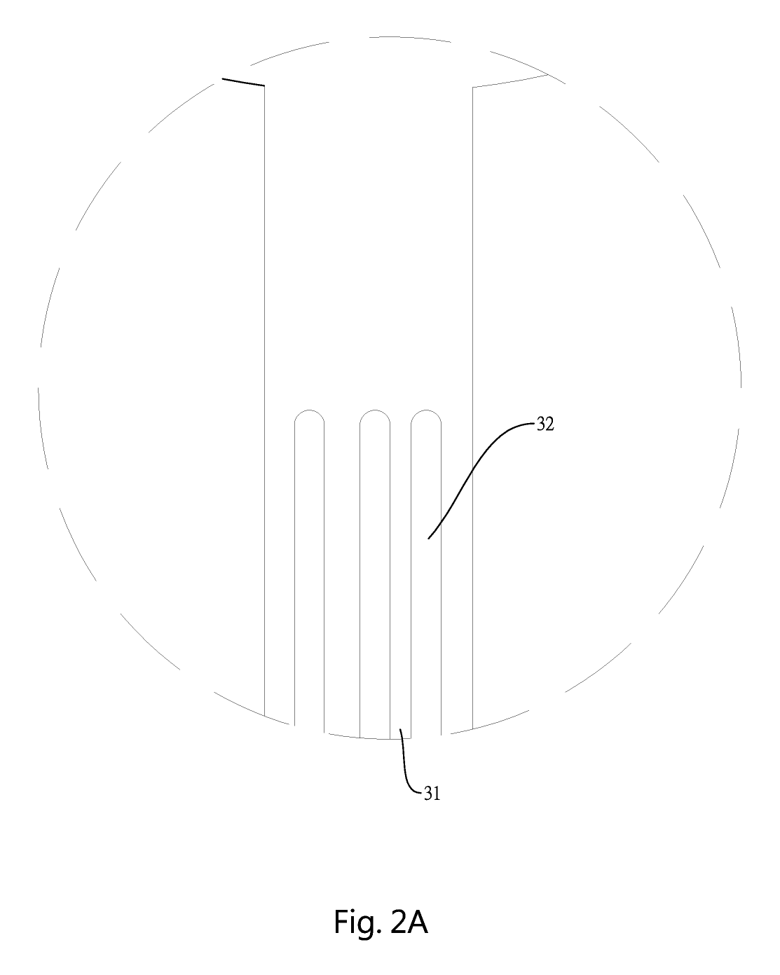

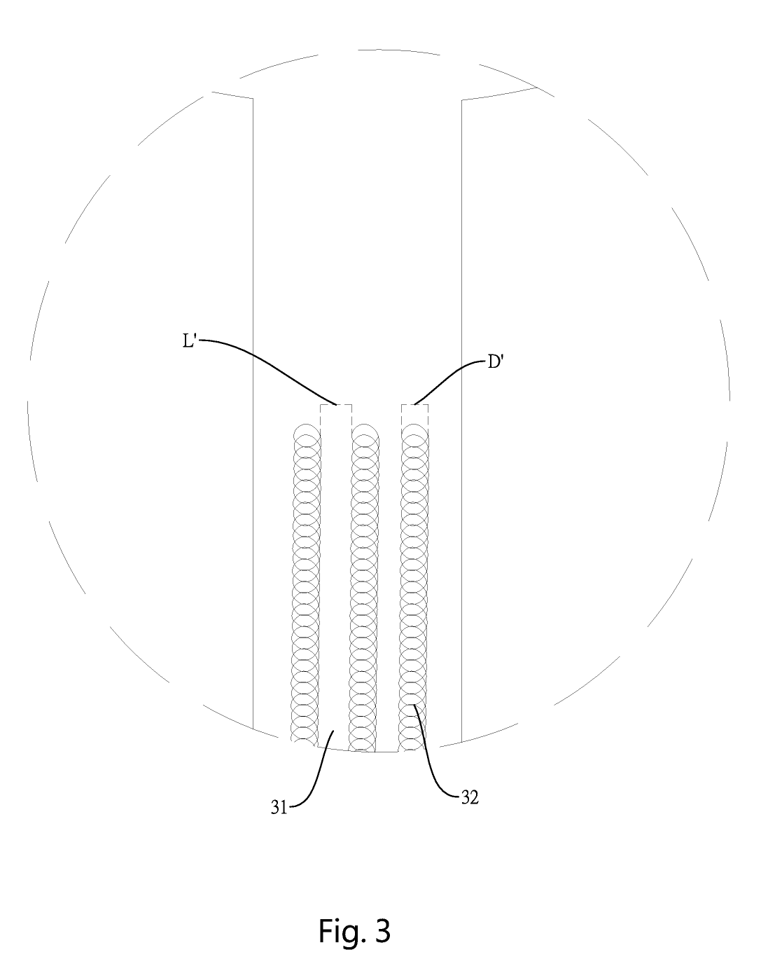

Referring to FIGS. 2 to 4, a process of manufacturing a copper coil in accordance with the invention is illustrated. The process comprises spirally cutting a piece of copper to form a plurality of grooves 32 therein by means of laser while adjusting a width D′ of each groove 32 to finish the copper coil 3 including a coil unit 31 having the grooves 32.

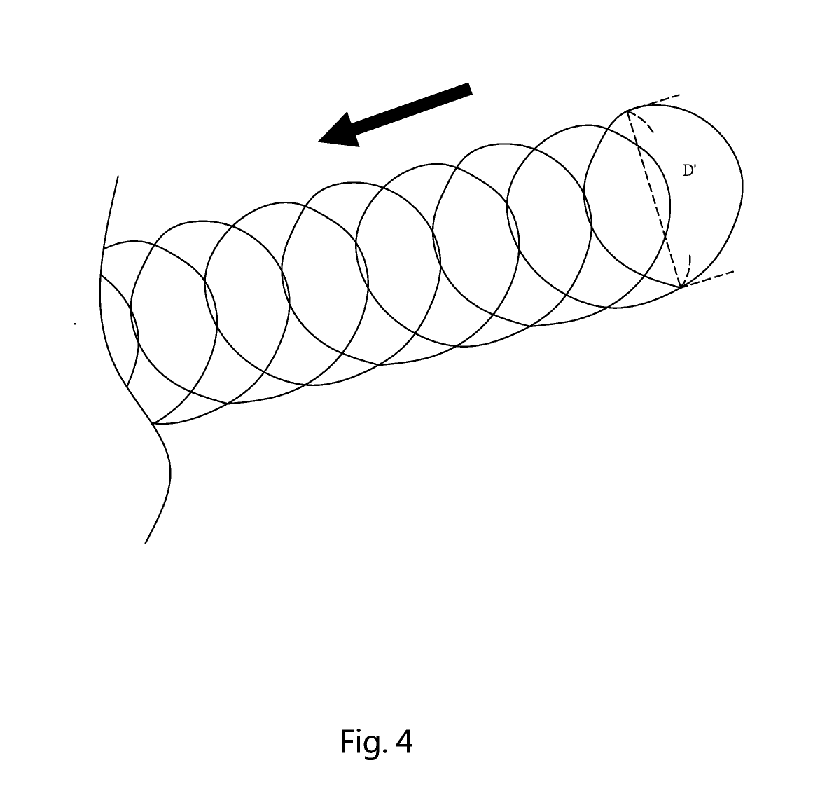

The cutting direction is indicated by arrow of FIG. 4.

Preferably, the piece of copper has a thickness of at least 100 mm.

Preferably, the coil unit 31 is either spiral or circular and has a diameter of no more than 40 mm.

It is envisaged by the invention that the adjustment of width D′ of each groove 32 is equivalent to setting the cutting width involved by the conventional laser cutting process. Thus, the coil unit 31 having a width L′ is formed after cutting the piece of copper to form the plurality of grooves 32 therein by means of laser

It is noted that it is possible of setting the width D′ of the groove 32 and density of the grooves 32, thereby facilitating the adjustment of groove width. Further, the denser of the grooves 32 the more powerful of the cutting is. And in turn, it facilitates the cutting of the grooves 32 or increases the depth of each groove 32. As a result, the complete coil unit 31 is made possible. In addition, the copper coil 3 is complete.

The copper coil 3 of the invention comprises a coil unit 31 including a plurality of grooves 32. The coil unit 31 has a width L′.

In the conventional art, the width of the groove is allowed to adjust in a range of 0.01 mm to 0.2 mm. That is, the cutting is limited to the range. Further, the adjustment is very difficult after selecting the set width of the groove. Alternatively, the adjustment is made possible only by replacing the cutting head with a new one or reprogramming.

The invention involves adjusting width D′ of each groove 32 to finish a copper coil 3 including a coil unit 31 having a width L′. In short, the adjustment of a diameter of the copper coil 3 is not direct but indirect.

The invention has the following advantages and benefits in comparison with the conventional art:

The laser cutting process is applicable to copper units 31 of different shapes such as circle or spiral. Yield of the finished copper coil 3 is greatly improved. The invention is applicable to cutting a piece of copper having a thickness of at least 100 mm. After adjustment, the coil unit 31 has a diameter of no more than 40 mm. The coil unit 31 can be customized. Cutting depths of the grooves 32 are uniform. Power is saved. Efficiency is greatly increased.

While the invention has been described in terms of preferred embodiments, those skilled in the art will recognize that the invention can be practiced with modifications within the spirit and scope of the appended claims.

What is claimed is:

1. A process of manufacturing a copper coil, comprising spirally cutting a piece of copper to form a plurality of grooves therein by means of laser while adjusting a width of each groove to finish the copper coil including a coil unit having the grooves.

2. The process of manufacturing a copper coil of claim 1, wherein the coil unit is spiral.

3. The process of manufacturing a copper coil of claim 2, wherein the coil unit has a diameter of no more than 40 mm.

4. The process of manufacturing a copper coil of claim 1, wherein the coil unit is circular.

5. The process of manufacturing a copper coil of claim 4, wherein the coil unit has a diameter of no more than 40 mm.

6. The process of manufacturing a copper coil of claim 1, wherein the piece of copper has a thickness of at least 100 mm.
